(19) United States
(12) Patent Application Publication
(10) Pub. No.: US 2012/0305825 A1
(43) Pub. Date: Dec. 6, 2012

(54) ENGINE VALVE FOR AUTOMOBILE MADE OF TITANIUM ALLOY EXCELLENT IN HEAT RESISTANCE

(76) Inventors: Kenichi Mori, Chiyoda-ku (JP); Hideki Fujii, Chiyoda-ku (JP); Tadayoshi Tominaga, Hazu-gun (JP); Norimichi Fukaya, Kariya-shi (JP)

(21) Appl. No.: 13/578,519

(22) PCT Filed: Feb. 24, 2011
(86) PCT No.: PCT/JP2011/054825

§ 371 Date: Aug. 10, 2012

(30) Foreign Application Priority Data
Feb. 26, 2010 (JP) 2010-042879

(51) Int. Cl. F16K 13/00

(52) U.S. Cl. 251/368

(57) ABSTRACT

The present invention provides an engine valve for an automobile made of titanium alloy which is excellent in heat resistance, which engine valve for an automobile made of titanium alloy comprises, by mass %, Al: 5.5% to less than 6.5%, Sn: 1.5% to less than 5.0%, Zr: 4.6% to less than 6.0%, Mo: 0.3% to less than 0.5%, Si: 0.35% to less than 0.60%, O: 0.05% to less than 0.14%, Fe+Ni+Cr: 0.01% to less than 0.07%, and a balance of titanium and unavoidable impurities. By being provided with such ingredients, the valve is excellent in room temperature ductility and impact resistance after high temperature exposure in addition to creep resistance and high temperature fatigue strength exceeding a conventional engine valve and can withstand use at a higher temperature and longer time than in the past.

### TECHNICAL FIELD

The present invention relates to engine valve for an automobile made of titanium alloy which is excellent in heat resistance.

### BACKGROUND ART

In the past, titanium alloys, which are light in weight, high in strength, and excellent in heat resistance, have been used for engine valves for automobile use. The demands on automobiles for higher output and improved fuel efficiency have also been rising. The heat resistance which is sought from exhaust valves has also been rising year by year.

As an engine valve which is excellent in heat resistance, PLT 1 discloses a method of production of an engine valve which forms a valve head with acicular microstructure at one end of a valve stem with equiaxed microstructure made of an α+β type or Near-αtype titanium alloy so as to improve the fatigue strength and tensile strength up to 800° C.

PLT 2 discloses an engine valve which has acicular microstructure from the valve head to the middle of the stem and has equiaxed microstructure in the rest of the stem portion so as to improve the creep resistance and fatigue strength at the time of a high temperature.

For the above exhaust valve, an α+β type alloy or Near-α type alloy which is excellent in heat resistance is used. As a typical alloy, for example, Ti-6Al-2Sn-4Zr-2Mo-0.1Si is known.

PLT's 3 to 5 discloses an engine valve for an automobile made of titanium alloy which has an oxide hardened layer at the surface.

PLT 6 discloses a heat resistant titanium alloy which is excellent in creep resistance and high temperature fatigue characteristics.

### CITATIONS LIST

### Patent Literature

PLT 1: Japanese Patent Publication (A) No. 2001-234313
PLT 2: Japanese Patent Publication (A) No. 2007-92535
PLT 3: Japanese Patent Publication (A) No. 2004-169128
PLT 4: Japanese Patent No. 2007-100666
PLT 5: Japanese Patent Publication (A) No. 2002-97914
PLT 6: Japanese Patent Publication (A) No. 2010-53419

### SUMMARY OF INVENTION

### Technical Problem

In the past, in automobile applications, titanium alloys have been used for the engine valves so as to improve engine performance and lower fuel consumption. However, for application to engine valves for automobiles, where the performance demanded has become tougher every year, it is desirable to improve the properties to match with the temperature of use—which may reach from 800° C. to 850° C. or more.

The inventors investigated and analyzed in depth the reasons for breakage of exhaust engine valves for automobiles and became aware of the following issues. That is, an exhaust engine valve breaks due to the load locally increasing more than envisioned due to creep deformation during use or insufficient proof stress. Therefore, in the past, the strength had been raised as a countermeasure. As opposed to this, the inventors thought that suppression of creep deformation was an important means for solution. At the same time, a drop in the high temperature fatigue strength and increased cost due to the use of special additive elements are unacceptable needless to say.

However, the leading heat resistant titanium alloy Ti-6Al-2Sn-4Zr-2Mo-0.1Si has the problem of a low creep resistance at a 850° C. high temperature.

The engine valve which is described in PLT 1 makes the valve head an acicular microstructure so as to try to improve the high temperature strength or fatigue strength of the valve head. Further, the engine valve which is described in PLT 2 is made an acicular microstructure from the valve head to the middle of the stem so as to try to achieve both the creep resistance of the valve head and the high temperature fatigue strength of the stem. In a titanium alloy, it is known that the material having acicular microstructure exhibits superior creep resistance than the material having equiaxed microstructure. Just making the microstructure an acicular structure however is insufficient for application to an engine valve for an automobile.

Further, Ti₃Al, TiAl, and other intermetallic compound phases are utilized to improve the high temperature fatigue strength and the creep resistance, but the room temperature ductility is low, so there were practical problems such as the susceptibility to breakage upon impact during manufacture or use. In titanium alloy including Al, it is known that the ductility falls in the case of long term exposure to high temperature region of around 600° C., but it is important that room temperature ductility be secured even after long term use as an exhaust engine valve at high temperature.

The engine valve for an automobile made of titanium alloy which is shown in PLT's 3 to 5 is a conventional titanium alloy engine valve which is formed on its surface with an oxide hardened layer. The room temperature ductility and creep resistance after long term exposure at high temperature are not improved.

The invention which is disclosed in PLT 6 is a heat resistant titanium alloy which is excellent in creep resistance and high temperature fatigue characteristics, but is not an engine valve for an automobile.

Therefore, the present invention advantageously solves the above problem and provides an engine valve for an automobile made of titanium alloy which is excellent in room temperature ductility after long-term exposure at high temperature in addition to the creep resistance and high temperature fatigue strength.

### Solution to Problem

The inventors engaged in intensive studies for achieving the above object, studied adjustment of the additive elements for improving the creep resistance and 0.2% proof stress at 850° C. or the room temperature ductility after high temperature exposure, and as a result discovered an engine valve for an automobile made of titanium alloy which has properties exceeding an existing engine valve and which is low in cost.

The present invention has as its gist the following:

(1) An engine valve for an automobile made of titanium alloy which is excellent in heat resistance characterized by comprising, by mass %, Al: 5.5% to less than 6.5%, Sn: 1.5% to less than 5.0%, Zr: 4.6% to less than 6.0%, Mo: 0.3% to less than 0.5%, Si: 0.35% to less than 0.60%, O: 0.05% to less than 0.14%, Fe+Ni+Cr: 0.01% to less than 0.07%, and a balance of titanium and unavoidable impurities.
(2) An engine valve for an automobile made of titanium alloy as set forth in (1) characterized in that an oxide hardened layer with a Vicker's hardness Hv of 500 or more is formed over at least part or all of the sliding surfaces of the surface of the engine valve by a thickness of 5 to 40 μm from the surface.
(3) An engine valve for an automobile made of titanium alloy as set forth in (1) or (2) characterized in that at least part or all of the sliding surfaces of the surface is covered by a hard coating of a thickness of 1 to 10 μm.

### Advantageous Effects of Invention

The engine valve for an automobile made of titanium alloy of the present invention has a creep resistance and high temperature fatigue strength which exceeds a conventional engine valve and is also excellent in room temperature ductility or impact resistance after high temperature exposure. It can withstand use at a higher temperature and for a longer time than in the past and enables automobile engines to be raised in output, reduced in fuel consumption, and increased in lifetime.

### BRIEF DESCRIPTION OF DRAWINGS

FIG. 1 is a view showing an automobile use engine valve by a front view.

### DESCRIPTION OF EMBODIMENTS

Below, the present invention will be explained in detail. Note that the % relating to the ingredients means mass % unless otherwise indicated.

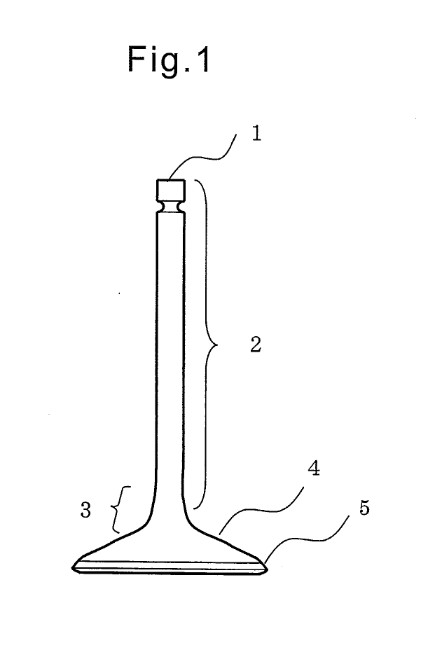

The shape of an exhaust engine valve is shown in FIG. 1. The exhaust engine valve has a stem end 1, a stem 2, a neck 3, and a valve head 4. The face 5 is a surface which contacts the valve seat, the stem 2 contacts the valve guide, and the stem end 1 contacts the rocker arm.

As an indicator of the creep resistance of the titanium alloy of the present invention, there is the heat resistant titanium alloy Ti-6Al-2Sn-4Zr-2Mo-0.1Si material, with a proven record in applications of engine valves for automobiles etc., as one indicator. A creep resistance at 850° C. above this is targeted. Specifically, in the method of evaluation of the creep resistance in the test conditions explained later, a creep deformation of 2% or less is targeted. Further, the 0.2% proof stress at 850° C. was made 130 MPa or more. The 0.2% proof stress at 850° C. of Ti-6Al-2Sn-4Zr-2Mo-0.1Si was about 90 MPa, so a great improvement in characteristics can be achieved by this indicator. Furthermore, as a mechanical property of the present invention at room temperature, the room temperature elongation after exposure to 600° C. for 960 hours was made 3% or more.

Here, the method of evaluation of the creep resistance in the present invention will be explained.

As the method of evaluation of the creep resistance, cantilever type test was employed. A weight was placed on the free end of a bar test piece which was held horizontally so that the working point of the weight matched with it. The distance from the fixed end of the test piece holder to the free end of the test piece, that is, the working point of the weight, was set to give a constant effective test piece length L. The creep deformation was evaluated from the deformation of the test piece after being held at 850° C. in the air for 24 hours. The deformation value, H, was the change of the height of the free end of the test piece between before and after the creep test. H/L expressed as a percentage was used as an indicator.

In the present invention described in the above (1), the ranges of ingredients of Al, Sn, Zr, Mo, Si, O, and Fe+Ni+Cr for achieving the above indicators are defined.

Al is an element with a high solution strengthening ability of the α-phase. If increasing the amount of addition, the creep resistance and 0.2% proof stress increase. To obtain a creep deformation of 2% or less and a 0.2% proof stress of 130 MPa or more at 850° C., addition of 5.5% or more is necessary. Preferably, it is 5.7% or more. However, if adding Al in 6.5% or more, the room temperature ductility for forming the brittle α₂-phase falls and the danger of the engine valve breaking during use increases. Therefore, the addition of Al is made less than 6.5%. Preferably, it is less than 6.3%.

Sn has the effect of strengthening both the α-phase and β-phase. These are effective elements in improving the strength of the α+β dual phase alloy. To obtain a 0.2% proof stress at 850° C. of 130 MPa or more, addition of 1.5% or more is necessary. Preferably, it is 2.0% or more. However, if adding 5.0% or more, an α₂-phase is formed and embrittlement occurs. Therefore, the amount of addition of Sn is made less than 5.0%. When segregation of Sn is liable to occur, to reliably suppress the formation of the α₂-phase, addition of less than 4.0% of Sn is preferable. More preferably, it is 3.0% or less.

Zr is an element which is effective for strengthening both the α-phase and the β-phase. Further, if simultaneously adding it together with Si, there is the effect of improving the creep resistance. If adding more than 6.0%, the creep resistance at 850° C. conversely falls, so the upper limit was made 6.0%. The preferable upper limit is 5.7%. The lower limit was made the 4.6% which is required for obtaining the creep resistance at 850° C. The preferable lower limit is 4.8%. Preferably, it is 5.0%.

Mo is a β-stabilizing substitution type element and acts to improve the hot rollability. To express this effect, the lower limit was made 0.3% or more. The preferable lower limit is 0.34%. However, at 850° C., if the β-phase is excessively present, the creep resistance falls, so upper limit was made less than 0.5%. The preferable upper limit is 0.45%. The more preferable upper limit is 0.40%.

Si is an element which improves the creep resistance. To improve the creep resistance, the amount of addition of Si has to be made 0.35% or more. Preferably, it is 0.40% or more. However, a large amount of addition tends to embrittle the titanium alloy due to the increase or coarsening of the intermetallic compounds formed with Ti and Zr. For this reason, the amount of addition of Si has to be made less than 0.60%. Preferably, it is 0.50% or less.

o is an element which strengthens the α-phase. To achieve this effect, O has to be 0.05% or more. Preferably, it is 0.07% or more. However, if adding O in 0.14% or more, this promotes the formation of the α₂-phase and embrittlement. Therefore, O has to be made less than 0.14%. Preferably, it is less than 0.10%.

Fe, Ni, and Cr are all β-stabilizing substitution type elements. If the β-phase is excessively present, the creep resistance and the 0.2% proof stress at 850° C. fall, so the inventors investigated the contents of these elements not having a detrimental effect and as a result found that Fe+Ni+Cr has to be less than 0.07%. Preferably, it is less than 0.05%. On the other hand, to stabilize the β-phase, Fe+Ni+Cr has to be made 0.01% or more. Further, Fe, Ni, and Cr are also unavoidably mixed into the sponge titanium used as the material of the engine valve.

In the present invention which is described in the above (2), for the thickness of the oxide hardened layer which is formed on at least the sliding surfaces of the engine valve, the thickness of the part of 500 Hv or more is preferably 5 to 40 μm from the surface. If less than 5 μm, the oxide hardened layer is liable to be consumed during use, while if over 40 μm, the hardened layer finely cracks etc. and the ductility and fatigue strength deteriorate. More preferably, the thickness should be made 10 to 30 μm. The “sliding surfaces” are parts where the engine valve contact other parts. The face 5 which contacts the valve seat, the stem 2 which contacts the valve guide, and the stem end 1 which contacts the rocker arm may be mentioned (see FIG. 1). It is also possible to form the oxide hardened layer at only the necessary parts of these sliding surfaces, that is, part or all of the sliding surfaces. The Vicker's hardness test is performed in the cross section of the engine valve with a load of 0.01N.

Such an oxide hardened surface layer, as explained later, is obtained by oxidation treatment which is performed after forming, cutting and the grinding the titanium alloy material of the present invention to the shape of an engine valve. Here, the oxidation treatment is the heat treatment in the air or in an oxidizing atmosphere containing 15% or more of oxygen at 700 to 850° C. for 30 minutes to 5 hours followed by air cooling. Furthermore, oxidation treatment at 750° C. to 830° C. for 45 minutes to 90 minutes is preferable. The oxidation treatment forms the oxide hardened surface layer and also serves as heat treatment for stabilizing the microstructure.

During use as an engine valve, it is important to obtain a balance between the action of reduction of the oxide hardened layer due to wear and the formation of the oxide hardened layer by progressive oxidation. For this reason, an oxide hardened layer of 500 HV or more is preferably formed in advance to a thickness of 5 to 40 μm. It was confirmed that by maintaining the thickness of the oxide hardened layer in the range of 5 to 40 μm, it is possible to use the engine valve of the present invention as an exhaust valve for a gasoline engine envisioning use for a motorcycle. Note that the method of confirmation is to run the engine at 12000 rpm for a cumulative 16 hours in an engine bench test.

In the present invention which is described in the above (3), the thickness of the hard coating which is formed on at least the sliding surfaces of the surface of the engine valve is preferably made 1 to 10 μm. This is because if thinner than 1 μm, the hard coating is liable to be worn away during use of the engine valve. On the other hand, if thicker than 10 μm, the hard coating will easily crack or chip. The thickness of the hard coating is more preferably made 2 to 6 μm. The hard coating is preferably formed at only the necessary parts of the sliding surfaces, that is, part or all of the sliding surfaces. The hard coating not only improves the wear resistance due to its hardness, but also cuts off the base material from the outside air or combustion gas to suppress oxidation during use and thereby suppress reduction of thickness due to scale peeling. Therefore, the formation of a hard coating is an effective means for reducing trouble at the time of use of the engine. The hard coating is, for example, CrN, TiN, TiAlN, etc.

Regarding the means for forming the hard coating, the ion plating method is suitable. The ion plating method can suppress the rise in temperature of the base material compared with other means.

The titanium alloy material for an exhaust engine valve of the present invention can be produced by the conventional method of production of a titanium alloy. The titanium alloy material thus produced for an exhaust engine valve can be provided with the excellent characteristics of the present invention.

The typical production process of a titanium alloy material of the present invention is as follows. Sponge titanium and alloy materials are melted by arc melting or electron beam melting in vacuum and cast into a water-cooled copper mold. Due to this, contamination by impurities is suppressed and a cast ingot of the titanium alloy ingredients of the present invention is made. The O (oxygen) in the cast ingot can be introduced by using as a material, for example, titanium oxide or sponge titanium with a high oxygen concentration. This cast ingot is heated at the range of 1100 to 1250° C., then is forged to a round billet of 100 mm diameter, then is reheated to the range of 1100 to 1250° C. and hot rolled to a round bar with 15 to 50 mm diameter or square bar with 15-50×15-50 mm.

The exhaust engine valve such as shown in FIG. 1 is produced by forming the stem 2 and the valve head 4 by hot working, solution treating above the β-transformation temperature followed by cooling at a rate of air cooling or less, then cutting, grinding, and oxidation treating. The example of forming processes are hot forging, hot extruding and joining the valve head and the stem after forming them separately. The solution treatment is performed for omogenization of the microstructure of the engine valve. This solution treatment keeps the exhaust engine valve from breaking during use.

The solution treatment is held at the range of 1050 to 1130° C. which is above the β-transformation temperature for 5 to 60 minutes and air cooled. After solution treatment, the material is cut, ground, and oxidation treated at 700 to 850° C. for 30 minutes to 5 hours followed by air cooling. The preferable oxidation treatment is performed by holding at 750° C. to 830° C. for 45 minutes to 120 minutes. The preferable solution treatment and oxidation treatment enable the precipitation of the acicular α-phase of a width of 10 μm or less inside the prior β-grains of a size of 100 to 800 μm. This acicular α-phase can be confirmed by observing a cross-section of the engine valve after heat treatment by an optical microscope. The microstructure mainly comprised of this acicular α-phase is preferable for the creep resistance.

If the solution treatment temperature is lower than 1050° C., the solubilization becomes insufficient, so the creep resistance falls. On the other hand, if the solution treatment temperature is higher than 1130° C., oxidation causes deterioration of the yield, so this is not preferred. If the holing time above the β-transformation temperature is shorter than 5 minutes, there is a possibility that the transformation to the β-phase is not finished. On the other hand, if the holding time is longer than 1 hour, the grains grow excessively coarsen and the fatigue strength decreased. Further, if the holding time above the β-transformation temperature is over 1 hour in the air, the oxide scale at the surface increases and the yield drops. For these reasons, the holding time above the β-transformation temperature is made 5 minutes to 1 hour. More preferably, it is 10 minutes to 30 minutes.

If the oxidation treatment temperature is lower than 700° C. or the holding time is less than 30 minutes, the stabilization of microstructure is not efficient and the characteristics greatly change during use at a high temperature. On the other hand, when the oxidation treatment temperature is higher than 850° C. or the holding time is over 5 hours, the yield or manufacturability decreases due to the thick scale.

### EXAMPLES

Next, the present invention will be further explained by examples, but the conditions in the examples are just an illustration which is employed for confirming the workability and advantageous effects of the present invention. The present invention is not limited to this illustration of conditions. The present invention can employ various conditions so long as not deviating from the gist of the present invention and achieving the object of the present invention.

### Example 1

The ingots about 10 kg in weight were produced by the vacuum arc melting method. Their chemical compositions are shown in Table 1. These ingots were forged, then cut to obtain 15 mm diameter bar. In Table 1, numerical values which are outside the rage of the present invention were underlined.

The engine valve for automobile use had the shape shown in FIG. 1. To obtain an engine valve shown in FIG. 1, first, a titanium alloy material was hot worked into the shape of an engine valve that consists of the stem 2 and the valve head 4, then was subjected to the and solution treatment at 1060° C. for 10 minutes. Further, that was cut, ground and heat treated at 800° C. for 1 hour. Test Nos. 1 to 13 are invention examples. These invention examples were all confirmed to have microstructures consist of acicular α-phases of 10 μm or less in width precipitated in the prior β-grains. Test Nos. 14 to 25 are comparative examples.

Table 1 shows the 0.2% proof stress, creep deformation at 850° C. and the room temperature elongation after the exposure at 600° C. for 960 hours in the air.

The 0.2% proof stress at 850° C. was 130 MPa or more except in Test Nos. 14, 16, 24, and 25 of the comparative examples. Al content is outside the suitable range in No. 14, Sn content is outside the suitable range in No. 16, Fe+Cr+Ni contents are outside the suitable range in No. 24, and Mo content is outside the suitable range in No. 25.

The exposure test method will be explained below. After holding at 600° C. for 960 hours, the materials were worked into tensile test specimens. Tensile tests were performed at room temperature, and the elongation was measured. Test Nos. 1 to 13 of the invention examples all exhibited excellent ductility. As opposed to this, Test Nos. 15, 17, 22, 23, and 25 of the comparative examples that had one of Al, Sn, Mo, Si and O content outside the range of suitable amounts exhibited less ductility after exposure.

The method of evaluation the creep resistance will be explained below. A 0.67±0.1 kg heat resistant alloy weight was placed on the stem end of the horizontally held engine valve and the deformation value, H, was measured after holding at 850° C. in the air for 24 hours. The deformation value, H, was the change of the height of the free end of the stem between before and after the creep test. The effective test piece length L from the fixed end, not including the holding part, to the free end of the engine valve was made 45 mm. Samples with a creep resistance H/L×100(%) of 2% or less were judged as good. Test Nos. 18, 19, 20, 21, and 24 of the comparative examples had either Zr, Mo, Si, or Fe+Ni+Cr content outside the range of the present invention and exhibit low in creep resistance. At part of the samples, the solution treatment was performed at 980° C. which was lower than the β-transformation temperature to obtain the equiaxed microstructure. When the creep resistance test were carried for these samples, the deformations were so large that the stem end reached the test device and the deformation measurement was impossible. The creep resistance for these specimens with equiaxed microstructure were remarkably low.

TABLE 1

| | | | | | | | | | | | Room |
|---|---|---|---|---|---|---|---|---|---|---|---|
| | | Alloy ingredient (mass %) | | | | | | | 850° C. | 850° C. | temperature |
| | | (bal. Ti) | | | | | | | proof | creep | elongation |
| | | | | | | | | Fe + | stress | deformation | after 600° C. |
| | No. | Al | Sn | Zr | Mo | Si | O | Ni + Cr | (MPa) | (%) | exposure (%) |
| Inv. ex. | 1 | 5.8 | 2.5 | 4.6 | 0.40 | 0.4 | 0.08 | 0.03 | 137 | 1.7 | 5.7 |
| Inv. ex. | 2 | 6.1 | 1.5 | 5.1 | 0.40 | 0.55 | 0.06 | 0.03 | 133 | 1.8 | 5.6 |
| Inv. ex. | 3 | 5.8 | 2.5 | 5.5 | 0.36 | 0.45 | 0.07 | 0.03 | 132 | 1.8 | 6.0 |
| Inv. ex. | 4 | 5.6 | 3.0 | 5.9 | 0.34 | 0.36 | 0.08 | 0.03 | 132 | 1.9 | 5.3 |
| Inv. ex. | 5 | 6.3 | 1.6 | 4.6 | 0.42 | 0.41 | 0.08 | 0.04 | 135 | 1.7 | 5.5 |
| Inv. ex. | 6 | 5.7 | 3.4 | 4.8 | 0.39 | 0.42 | 0.07 | 0.04 | 133 | 1.7 | 5.2 |
| Inv. ex. | 7 | 5.6 | 4.5 | 4.6 | 0.34 | 0.36 | 0.06 | 0.04 | 131 | 1.7 | 5.0 |
| Inv. ex. | 8 | 5.8 | 2.9 | 5.9 | 0.31 | 0.37 | 0.06 | 0.03 | 131 | 1.9 | 5.6 |
| Inv. ex. | 9 | 5.7 | 2.1 | 5.4 | 0.48 | 0.45 | 0.07 | 0.05 | 135 | 1.8 | 5.7 |
| Inv. ex. | 10 | 5.7 | 2.3 | 5.3 | 0.41 | 0.36 | 0.09 | 0.03 | 138 | 1.8 | 5.5 |
| Inv. ex. | 11 | 5.8 | 2.6 | 5.1 | 0.44 | 0.55 | 0.05 | 0.04 | 136 | 1.8 | 5.4 |
| Inv. ex. | 12 | 5.5 | 1.7 | 4.7 | 0.41 | 0.38 | 0.13 | 0.02 | 133 | 1.7 | 5.1 |
| Inv. ex. | 13 | 6.0 | 2.2 | 5.3 | 0.48 | 0.44 | 0.06 | 0.06 | 134 | 1.8 | 5.4 |
| Comp. ex. | 14 | 4.8 | 3.2 | 5.6 | 0.38 | 0.4 | 0.10 | 0.04 | 121 | 1.9 | 5.5 |
| Comp. ex. | 15 | 6.8 | 3.0 | 5.1 | 0.35 | 0.45 | 0.08 | 0.04 | 136 | 1.8 | 2.1 |
| Comp. ex. | 16 | 5.9 | 1.2 | 5.5 | 0.40 | 0.45 | 0.10 | 0.04 | 125 | 1.8 | 5.0 |
| Comp. ex. | 17 | 5.6 | 5.1 | 5.1 | 0.40 | 0.46 | 0.07 | 0.05 | 133 | 1.8 | 2.7 |
| Comp. ex. | 18 | 5.9 | 2.3 | 3.5 | 0.40 | 0.46 | 0.09 | 0.04 | 130 | 2.2 | 5.6 |
| Comp. ex. | 19 | 5.8 | 2.5 | 6.5 | 0.40 | 0.45 | 0.07 | 0.04 | 131 | 2.2 | 4.3 |
| Comp. ex. | 20 | 5.8 | 2.5 | 4.9 | 0.70 | 0.44 | 0.10 | 0.06 | 134 | 2.4 | 3.6 |
| Comp. ex. | 21 | 5.7 | 2.3 | 5.0 | 0.41 | 0.30 | 0.07 | 0.05 | 130 | 2.2 | 7.0 |
| Comp. ex. | 22 | 6.0 | 3.0 | 5.2 | 0.45 | 0.65 | 0.11 | 0.04 | 132 | 1.8 | 0.8 |
| Comp. ex. | 23 | 5.9 | 3.0 | 5.4 | 0.45 | 0.41 | 0.16 | 0.04 | 135 | 1.8 | 0.4 |
| Comp. ex. | 24 | 5.8 | 2.1 | 5.7 | 0.48 | 0.41 | 0.08 | 0.08 | 120 | 2.4 | 5.0 |
| Comp. ex. | 25 | 6.0 | 2.4 | 5.7 | 0.23 | 0.40 | 0.08 | 0.06 | 115 | 1.9 | 4.7 |

### Example 2

The effect of suppression of oxidation when coating the engine valve for an automobile made of titanium alloy of the present invention with a hard coating was evaluated. The method of evaluation will be explained. The material which was described in No. 3 of Table 1 was used to produce an exhaust engine valve by the method described in Example 1. The cross-sectional hardness of the exhaust engine valve before the test was 330 HV. In case of the CrN coating had not formed at the surface, the thickness of the hardened layer with 500 HV or more reached to 40 μm at a maximum from the surface, after exposing the exhaust engine valve at 850° C. for 5 hours in the air. However, when 5 μm thick CrN coating had been formed, the hardened layer having 500 HV or more was not observed in the base material, titanium alloy. It was confirmed that the CrN coating or other hard coating contributed to suppress oxidation.

### Example 3

Table 2 shows the results of a wear resistance test on the engine valve for automobile use of the present invention.

TABLE 2

| | | |
|---|---|---|
| 500 Hv or more | | |
| oxide hardened | Hard coating | Wear resistance |
| layer thickness | thickness | (cracking) |

| No. | (μm) | (μm) | 5 × 10⁶ | 1 × 10⁷ |
|---|---|---|---|---|
| 1 | 3 | — | No | Yes |
| 2 | 15 | — | No | No |
| 3 | 30 | — | No | No |
| 4 | 40 | — | No | No |
| 5 | — | 5 | No | No |
| 6 | 6 | 2 | No | No |
| 7 | 50 | — | No | Yes |
| 8 | — | 0.5 | No | Yes |
| 9 | — | 8 | No | Yes |

As the test material, the material which is described in No. 3 of Table 1 made into an exhaust engine valve by the method which is described in Example 1 was used. This engine valve was ground, then treated by the later explained oxidation treatment. The wear resistance was evaluated by applying a tensile load in the axial direction of the engine valve material, then causing an SCM435 material to strike the stem surface at room temperature in the air by a load of 98N (10 kgf) and a vibration frequency of 500 Hz and examining for the presence of cracks at the engine valve surface after an endurable number of cycles in a vibration test of 5×10⁶ cycles and 1×10⁷ cycles. At the time of actual use in an engine, an oxide layer grew due to high temperature oxidation, so the reduction in thickness of the oxide layer due to wear was suppressed and the wear resistance became more advantageous. In this test, the oxide layer was not replenished, so this test can be said to be more severe than the actual usage environment.

Nos. 2 to 4 respectively show cases of forming oxide hardened layers of Hv of 500 or more in the air. No. 2 shows the case of holding at 830° C. for 1 hour, No. 3 shows the case of holding at 830° C. for 4 hours, and No. 4 shows the case of holding at 850° C. for 5 hours so as to form Hv 500 or more oxide hardened layers to thicknesses which are described in Table 2. Nos. 2 to 4 all held high wear resistances even after an endurable number of cycles in a vibration test of 1×10⁷ cycles. No. 1 shows the case of a thin oxide hardened layer in the case of holding in the air at 720° C. for 30 minutes and did not crack up to an endurable number of cycles in a vibration test of 5×10⁶ cycles. However, after that, it could be confirmed that No. 1 was worn down in oxide layer, cracked at 1×10⁷ cycles, and fell in wear resistance. No. 5 shows the case of using ion plating to form a 5 μm thick TiN hard coating and has a high wear resistance.

No. 6 shows the case of holding in the air at 780° C. for 30 minutes, then using ion plating to form a 2 μm thick CrN hard coating and has a high wear resistance.

No. 7 shows the case of holding in the air at 850° C. for 8 hours so as to form an Hv 500 or more oxide hardened layer of 50 μm. No. 7 did not crack up to an endurable number of cycles in a vibration test of 5×10⁶ cycles. However, after this, No. 7 was reduced in oxide layer due to wear and cracked at an endurable number of cycles in a vibration test of 1×10⁷ cycles.

Nos. 8 and 9 show cases of using ion plating to form 0.5 μm and 8 μm thickness TiN hard coatings. Nos. 8 and 9 were both free of cracks up to a endurable number of cycles in a vibration test of 5×10⁶ cycles. However, after this, Nos. 8 and 9 both were damaged in hard coating layers and cracks at an endurable number of cycles in a vibration test of 1×10⁷ cycles.

Note that, the above description only illustrates embodiments of the present invention. The present invention can be changed in various ways within the scope of the description of the claims.

### INDUSTRIAL APPLICABILITY

As explained above, the engine valve for an automobile made of titanium alloy of the present invention can withstand higher temperature and longer term use inside an engine compared with the past. Therefore, according to the present invention, it is possible to achieve a higher output, lower fuel consumption, and longer lifetime of an automobile engine. The present invention contributes to reduction of the manufacturing costs of an automobile. Accordingly, the present invention is high in value of utilization in industry.

### REFERENCE SIGNS LIST

1 stem end
2 stem
3 neck
4 spindle
5 face

1. An engine valve for an automobile made of titanium alloy which is excellent in heat resistance characterized by comprising, by mass %, Al: 5.5% to less than 6.5%, Sn: 1.5% to less than 5.0%, Zr: 4.6% to less than 6.0%, Mo: 0.3% to less than 0.5%, Si: 0.35% to less than 0.60%, O: 0.05% to less than 0.14%, Fe+Ni+Cr: 0.01% to less than 0.07%, and a balance of titanium and unavoidable impurities.

2. An engine valve for an automobile made of titanium alloy as set forth in claim 1 characterized in that an oxide hardened layer with a Vicker's hardness Hv of 500 or more is formed over at least part or all of the sliding surfaces of the surface of said engine valve by a thickness of 5 to 40 μm from the surface.

3. An engine valve for an automobile made of titanium alloy as set forth in claim 1 characterized in that at least part or all of the sliding surfaces of the surface is covered by a hard coating of a thickness of 1 to 10 μm.

4. An engine valve for an automobile made of titanium alloy as set forth in claim 2 characterized in that at least part or all of the sliding surfaces of the surface is covered by a hard coating of a thickness of 1 to 10 μm.
